(19) United States
(12) Patent Application Publication
(10) Pub. No.: US 2009/0130539 A1
(43) Pub. Date: May 21, 2009

(54) ELECTRIC POWER GRID BUFFER

(76) Inventor: Robert Van Burdine, Ardmore, TN (US)

Correspondence Address: CONNOLLY BOVE LODGE & HUTZ LLP, 1875 EYE STREET, N.W., SUITE 1100, WASHINGTON, DC, 20006, US

(21) Appl. No.: 11/943,383

(22) Filed: Nov. 20, 2007

(51) Int. Cl. H01M 2/38

(52) U.S. Cl. 429/51; 429/81

(57) ABSTRACT

An electric power grid buffer for storing electric energy by converting low energy electrochemistry waste into higher energy electrochemistry fuel and supplying electric energy to an electric power grid by discharging the higher energy electrochemistry fuel under production of low energy electrochemistry waste. In one embodiment, the electric power grid buffer stores electric energy generated by renewable energy sources, such as wind power or solar cells, and supplies an electric current to an electric power grid such that the renewable energy source is completely isolated from the electric power grid.

### FIELD OF THE APPLICATION

This application relates to an electrochemical energy device comprised of a spatially separated electrochemical charging system and electrochemical discharge cell, and to the complementary use of these devices in the form of a battery for electric power grid and renewable power storage, electric power buffering and electric power delivery.

### BACKGROUND OF THE APPLICATION

Electric power grids suffer from a cyclic variation in demand that requires the electric power generation resource to maintain a wide range of generation capacity or generate excess power that is lost as heat during times of low demand. Also, the generating capacity must be constructed to meet the peak power demand times, even though this top 10% of demand may exist for only a few hours each day. It is desirable to store otherwise wasted electrical energy as an electrochemical fuel and at times of peak demand supply that electrical energy back to the electric power grid.

Renewable energy sources, such as wind and solar, are often unstable and somewhat unpredictable.

In the case of wind energy, several issues concerning the electrical behavior of wind turbines are very undesirable. The production of a ‘voltage flicker’ is the usual result of such anomalies. Voltage flicker is a momentary sag in line voltage that results in perceptible fluctuations in the intensity of light from lamps supplied by a time-varying voltage source. There are three potential sources of flicker associated with wind turbines. The first is due to voltage fluctuations that may occur as a direct result of power fluctuations from the wind turbine under normal operation in turbulent winds. A second source of flicker is voltage drop resulting from the magnetizing inrush current that occurs when an induction generator is first electrically connected to a grid. When this connection is made at full voltage through a contactor or circuit breaker, the inrush is often several times the full load current of the generator, and can last for several line cycles, enough to be perceptible to the human eye. The third and final source of flicker is due to the tower shadow effect. Each passing of a wind turbine blade by the tower creates a small output power pulsation. In a balanced electric power grid, these power variations cause far reaching disturbances. Much work has been done concerning the electronics controlling the wind turbine to minimize these effects, though they must still be considered in any electric power grid design as their mitigation is incomplete.

Solar photovoltaic systems suffer from power variations caused by the occasional passing cloud and other shadow or surface contamination (such as dust or wind blown plant debris) effects that directly and immediately shift their power and voltage output.

It is therefore desirable to decouple renewable energy sources such as wind turbines and solar photovoltaic farms from the electric power grid due to excessive inrush currents, large voltage swings, and other power variations that are typical of such devices and are disruptive to the stability of an electric power grid. Conventional storage batteries do not offer isolation from these issues as their charge and discharge components are connected simultaneously to the renewable energy source and the electric power grid.

The ability to provide continuous electrical power at high current drain rates from a conventional battery over long periods of time is problematic due to the consumption of the fuel components in the battery as well as the limited volume of electrochemical fuel that can be contained within the battery. Also, the accumulation of reaction products inside the battery, e.g., in the form of sludge deposits against the surface of the conducting electrodes, reduces the overall efficiency of the electrochemical processes and thereby limits the discharge cycle. The use of conventional batteries is further hampered by the eventual requirement for their disposal.

Standard batteries have a limited cycle, or number of recharges, due to the disarrangement of their electroactive components. This means that the electroactive components undergo a chemical and physical change during the discharge process, and during the charging process these chemical reactions are reversed. But during the process the electroactive materials are depleted in some areas and concentrated in other areas due to small inconsistencies within the battery cell. This process causes a structural deficiency that eventually renders the battery cell inoperative and requires that it be disposed of and replaced. Typical batteries contain materials that are hazardous and it is usually undesirable to dispose of them in an economically sound manner.

Electric power grid storage and delivery systems as well as renewable energy storage and delivery systems both require a high and continuous rate of energy delivery. It is also desirable to be able to store electrical power as chemical energy and deliver that electrical power on demand. In the case of the electric power grid, it is desirable to store energy during off-peak demand times when excess energy is available from time to time on the electric power grid. This storage of energy is desirable to be obtained over many hours or days of operation. However, when the electric power is in demand during the on-peak periods of electrical surge, it is desirable to discharge this energy into the electric power grid at a high rate of speed. This is also true in the case of renewable energy. The sun only shines and the wind only blows when it does. Photocells and wind turbines produce energy when there is natural energy to collect, not necessarily during the demand times for electrical power. It is therefore desirable to store the electrical power produced as chemical energy over the entire collection period, and deliver that energy to the electric power grid during times of peak demand.

Metal/metal flow batteries include two metal based electrodes in electrolyte solution, for alkaline cells usually NaOH or KOH. The metal fuels and electrolyte are added periodically in a manner analogous to the refueling of an engine. At the same time, the spent electrolyte containing the spent electrochemical fuels produced during discharge are removed from the cell. The metal fuel and electrolyte can then be regenerated by electrolysis and/or various chemical or thermal reduction techniques at a fixed industrial or service site in a continuous process driven by the electrical energy available from time to time, thereby constituting recharging of the electrochemical fuel. Thus, a fixed quantity of metals and electrolyte would be recycled indefinitely between the charger and the discharger. The present application provides for the use of a metal-metal cell which provides for the maximum discharge rate to deliver power. Low cost and high charge and discharge rates are desirable for the electric power grid buffer and renewable energy electric power storage and delivery industries. System weight is not an issue in such systems.

Given the above description of the art, the development of an electrochemical cell and use of such a cell in the form of a battery that can be charged as energy is available, and has a high rate of discharge, is of great interest. As such, it would be desirable to provide a battery that has full (100%) consumption of the added particles and which maintains low resistance and does not become clogged or caked with accumulated reaction products. It is also desirable to have a battery that can maintain a high rate of discharged energy delivery. Also, such a battery can have applications as an electric power grid energy storage and discharge device, a renewable energy power storage and discharge device, and a stand-alone electric generating unit, e.g., at a remote and/or environmentally hostile location, to reliably generate electrical power on demand for an extended period of time.

### SUMMARY

This application is directed to an electrochemical cell comprising two electrodes with electrochemical metal fuel compartments. The fuel compartments include input and output sidewalls of dimension h and end walls of dimension w. The individual fuel compartment is arranged between an input flow plate and output flow channel with the input flow plate adjacent to the input side wall and the output flow channel adjacent to the output side wall of the fuel compartment. The input flow plate comprises a porous membrane or a plurality of openings through which electrolyte can flow into the fuel compartment from an electrolyte source. The input flow plate directs the flow of the electrolyte through the fuel compartment in a direction essentially parallel to dimension w and into the output flow channel.

The application is also directed to the separation of the charge and discharge functions, and their cooperative and complimentary usage as an electric power grid buffer and a renewable energy isolation and buffering system.

### BRIEF DESCRIPTION OF THE DRAWINGS

These and other features of the present application will become apparent upon consideration of the following detailed description of the application when read in conjunction with the drawings, in which:

FIG. 1 is a schematic cross-sectional representation of one embodiment of an electrochemical cell;

FIG. 2 is a schematic representation of another embodiment of an electrochemical cell;

FIG. 3 is a schematic representation of the charging of electrochemical fuel from power provided by the electric power grid;

FIG. 4 is a schematic representation of the discharging of electrochemical fuel providing electrical power to the electric power grid;

FIG. 5 is a schematic representation of the complete cycle of electric power grid buffering;

FIG. 6 is a schematic representation of a wind farm's electrical production being provided to an electrochemical charging system, and the provision of non grid related inrush current for wind turbine generator starting;

FIG. 7 is a schematic representation of a photovoltaic farm's electrical production being provided to an electrochemical charging system; and

FIG. 8 is a schematic representation of renewable electrical power being buffered and then provided to the electric power grid on demand.

### DETAILED DESCRIPTION OF THE PREFERRED EMBODIMENTS

The application is an electrochemical cell comprising two opposing fuel compartments with input and output sidewalls of dimension h and end walls of dimension w. The individual fuel compartment is arranged between an input flow plate and output flow channel. The input flow plate is positioned adjacent to the input side wall and the output flow channel is positioned adjacent to the output side wall of the fuel compartment. The input flow plate comprises a porous membrane or a plurality of openings through which electrolyte can flow into the fuel compartment from an electrolyte source. The porous membrane or the openings extend substantially along a surface of the input flow plate adjacent to the input side wall of the fuel compartment. The input flow plate facilitates the flow of the electrolyte from the electrolyte source through the fuel compartment in a direction essentially parallel to dimension w and toward the output flow channel.

The metal-metal cell of the present application might be, as an example, a combination of zinc in the negative electrode and iron oxide, in the form of FeOOH in the positive electrode. This provides for a heavy but low cost electrochemical fuel material that is readily charged and discharged in the continuous cycle as per the present application. Typical materials that may be utilized in the present application include, but are not limited to, the following table of materials in all possible combinations.

| Anode Materials | Cathode Materials |
|---|---|
| Most Negative | Most Positive |
| Lithium | Ferrate |
| Magnesium | Iron Oxide |
| Aluminum | Cuprous Oxide |
| Zinc | Iodate |
| Chromium | Cupric Oxide |
| Iron | Mercuric Oxide |
| Nickel | Cobaltic Oxide |
| Tin | Manganese Dioxide |
| Lead | Lead Dioxide |
| Hydrogen | Silver Oxide |
| Copper | Oxygen |
| Silver | Nickel Oxyhydroxide |
| Palladium | Nickel Dioxide |
| Mercury | Silver Peroxide |
| Platinum | Permanganate |
| Gold | Bromate |
| Least Negative | Least Positive |

The term “output and input side walls” as related to the fuel compartment refers to actual structural side walls of the fuel compartment as well as regions of the fuel compartment that are in direct contact with an adjacent component of the electrochemical cell. For example, an output side wall of the fuel compartment can be defined by a structural wall of the adjacent output flow channel. Likewise, an input side wall of the fuel compartment can be defined by a structural wall of the adjacent input flow plate. Accordingly, the term “output and input side walls” is used to designate in space a physical boundary between the fuel compartment and the adjacent components of the electrochemical cell.

The electrochemical cell can also include one or more screens that extend substantially between and along the output side wall of the fuel compartment and the output flow channel. The term “screen” refers to a porous substrate with a plurality of openings that allows particles with a diameter smaller than the average pore (opening) size of the substrate, or a fluid such as electrolyte, to readily pass through the substrate whereas relatively large particles cannot pass through the substrate. It is to be understood that one of ordinary skill would recognize that the term screen used in this context includes a porous cloth or a porous membrane.

The input flow plate directs the input of electrolyte from an electrolyte source to the electrochemical fuel compartment. The input flow plate is positioned adjacent to the input side wall of the fuel compartment, and comprises a porous membrane or a plurality of openings through which electrolyte can flow into the fuel compartment from an electrolyte source. The porous membrane or the openings extend substantially along a surface of the input flow plate adjacent to the input side wall of the fuel compartment. The input flow plate facilitates the flow of the electrolyte from the electrolyte source through the fuel compartment in a direction essentially parallel to dimension w and toward the output flow channel.

As with the one or more screens that extend substantially between and along the output side wall of the fuel compartment, the input flow plate of the electrochemical cell can be electrically conductive or electrically non-conductive. In one embodiment, the input flow plate comprises a screen. In another embodiment, the input flow plate can be fabricated from metal sheet.

The output flow channel directs the electrolyte that has passed through the electrochemical fuel compartment out of the cell. The electrolyte that enters the output flow channel also contains a significant amount of electrochemical reaction products that are produced in the fuel compartment of the cell. Both the input flow plate and the output flow channel of the electrochemical cell are designed to direct the flow of the electrolyte across the fuel compartment in a direction essentially parallel to dimension w of the fuel compartment. As a result, the electrolyte and the reaction products flow or move along relatively short distances through the cell and into the output flow channel. The flow design of the electrochemical cell minimizes the build-up or the residence time of the reaction products in the fuel compartment. For example, if one of the electrochemical fuels comprises active zinc, the resulting zinc oxide and zinc hydroxide are directed to the output flow channel with the electrolyte and out of the cell.

A discharge fluid containing electrolyte, the electrochemical reaction products and small amounts of unreacted fuel particles exit the electrochemical cell from the output flow channel. The discharge fluid can then be treated to separate the reaction products and unreacted fuel particles from the electrolyte. The electrolyte obtained from the treated discharge fluid can then be returned to the electrochemical cell, i.e., the input flow plate. The discharge fluid can be treated by any suitable chemical treatment and/or physical separation methods.

The anode and cathode material is typically comprised of particles of electrochemically active metals, compounds, or composites. Examples of electrochemically active particles include zinc, compounds of zinc, aluminum spheres, iron, cadmium or lead particles in an alkaline electrolyte, and calcium particles in mixed alkaline and halide solutions.

One of the more preferred electrochemically active metals are porous zinc particles, which are present in an amount of about 10% to 70% by weight relative to the weight of the electrolyte in the fuel compartment. The porous zinc will preferably have a density which is 5 to 20% of the density of non-porous zinc, e.g. it may have a density within the range of 0.3 to 1.4 g/cm³, preferably 0.3 to 1.1 g/cm³, and a surface area within the range 0.5 to 6.0 m²/g, preferably 0.75 to 5.0 m²/g.

The electrolyte is provided to the electrochemical cell from an electrolyte source. In some cases, the electrolyte is provided to the cell at a desired pressure. The electrolyte passes through the input flow plate, travels across the fuel compartment in a direction essentially parallel to dimension w of the fuel compartment, toward the output flow channel and eventually out of the cell. Suitable flow rates for the electrolyte through the cell are in the order of about 0.01 to 100 m³/min. Optimal flow rates can be determined by one of ordinary skill in the art. The flow of the electrolyte can be from the flow area between the metal electrode out thereby providing for separate waste streams for each metal fuel, or from the opposing sides into the centrally located flow are combining and mixing the waste streams. The preferred method of flow is determined by the chemical properties of the waste streams from each electrode.

The electrolyte can be aqueous, e.g., alkaline, saline or acid, or even non-aqueous. The electrolyte must be chosen in relation to the metal fuel materials of the cell so that the electrochemical reaction will proceed with a minimum of parasitic reactions. The use of a saline (salt) electrolyte is possible, however, an alkaline electrolyte is one which is generally the most advantageous to use. In fact, the oxidation of metals such as zinc can be conducted in an alkaline environment with rapid agitation, and zinc is oxidized with current densities which are very high. The alkaline electrolyte is preferably a solution of sodium hydroxide or potassium hydroxide, preferably the latter or a mixture of both. Its concentration can range from 0.01 N to 13.5 N, but it is preferably between 7 and 13.5 N.

All or a portion of the electrolyte passing through the cell can be regenerated. The regeneration of the electrolyte can be accomplished by any suitable means for regeneration of the electrolyte such as removal of the reaction products, e.g., zincate particles, from the electrolyte. The electrolyte is provided to the cell with an electrolyte input system.

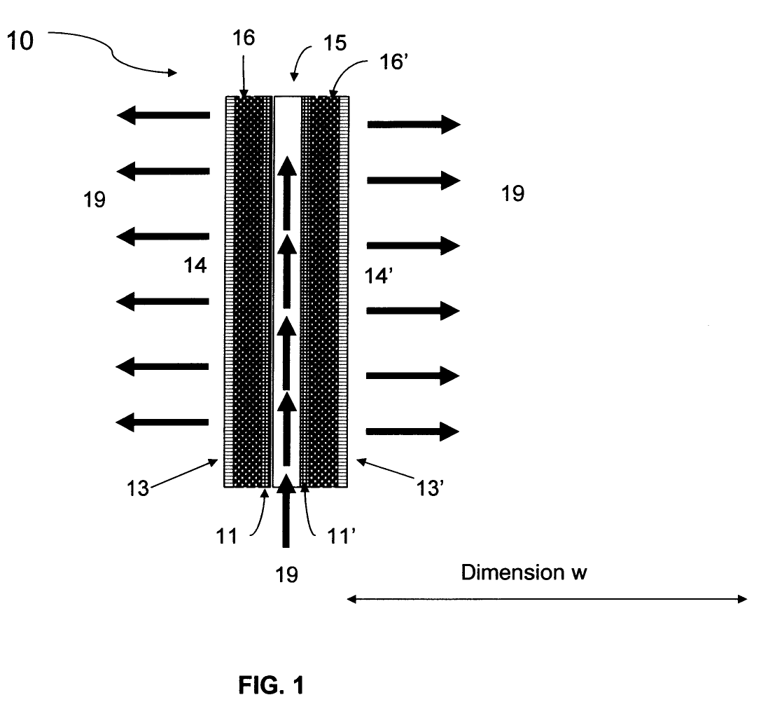

The electrochemical cell(s) can be arranged in any number of spatial configurations including a cylindrical configuration or a block configuration. For example, FIG. 1 is a schematic cross-sectional representation of an electrochemical cell 10 in which the electrolyte entry flow area 15 is centrally positioned and the components of the cell are in a block configuration. As shown, two output flow channels 14 and 14′ are provided on either side of the fuel compartments 16 and 16′. The electrolyte 19 is shown entering the cell from the bottom, but may enter from the top or side as desired for a particular configuration. The one or more screens 13 and 13′, fuel compartments 16 and 16′ and the two input flow plates 11 and 11′ are centrally arranged about the flow channel 15. Electrolyte 19 flows through the fuel compartments 16 and 16′ separating into two waste streams exiting the cell through flow channels 14 and 14′.

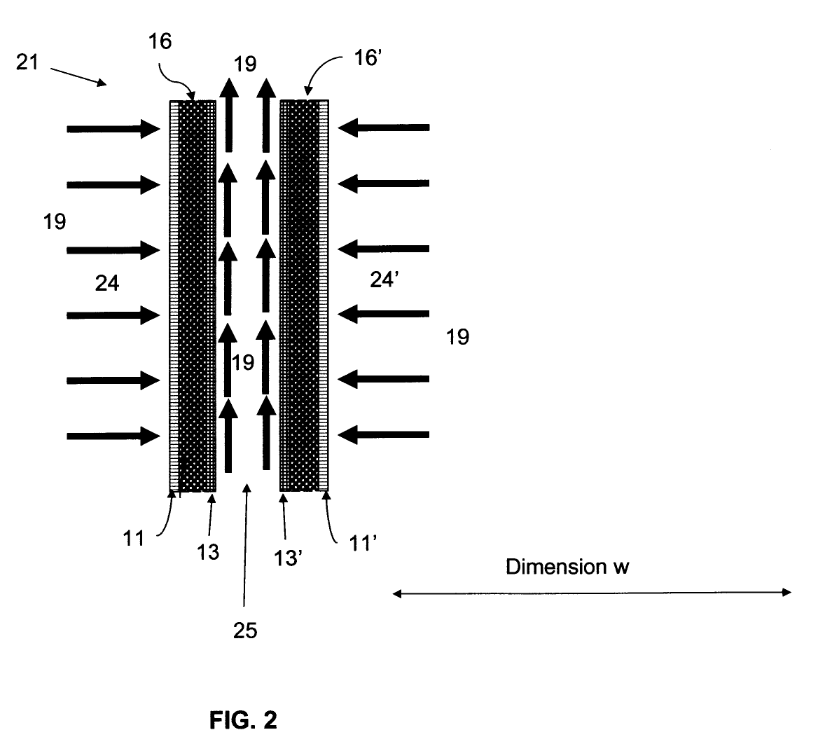

FIG. 2 is a schematic cross-sectional representation of an electrochemical cell 21 in which the electrolyte exit flow area 25 is centrally positioned and the components of the cell are in a block configuration. As shown, two input flow channels 24 and 24′ are provided on either side of the fuel compartments 16 and 16′. The electrolyte 19 is shown exiting the cell from the top, but may exit from the bottom or side as desired for a particular configuration. The one or more screens 13 and 13′, fuel compartments 16 and 16′ and the two input flow plates 11 and 11′ are centrally arranged about the exit flow channel 25. Electrolyte 19 flows through the fuel compartments 16 and 16′ combining into a single waste stream exiting the cell through flow channel 25.

The input flow plates shown in FIGS. 1 and 2 can be a porous membrane or a substrate with a plurality of openings through which electrolyte can flow into the fuel compartments from the electrolyte source. The porous membrane or the openings extend substantially along a surface of the input flow plates adjacent to the input side wall of the fuel compartments, and thereby provide for the flow of the electrolyte through the fuel compartments in a direction essentially parallel to dimension w and toward the output flow channels proximate to the electrode.

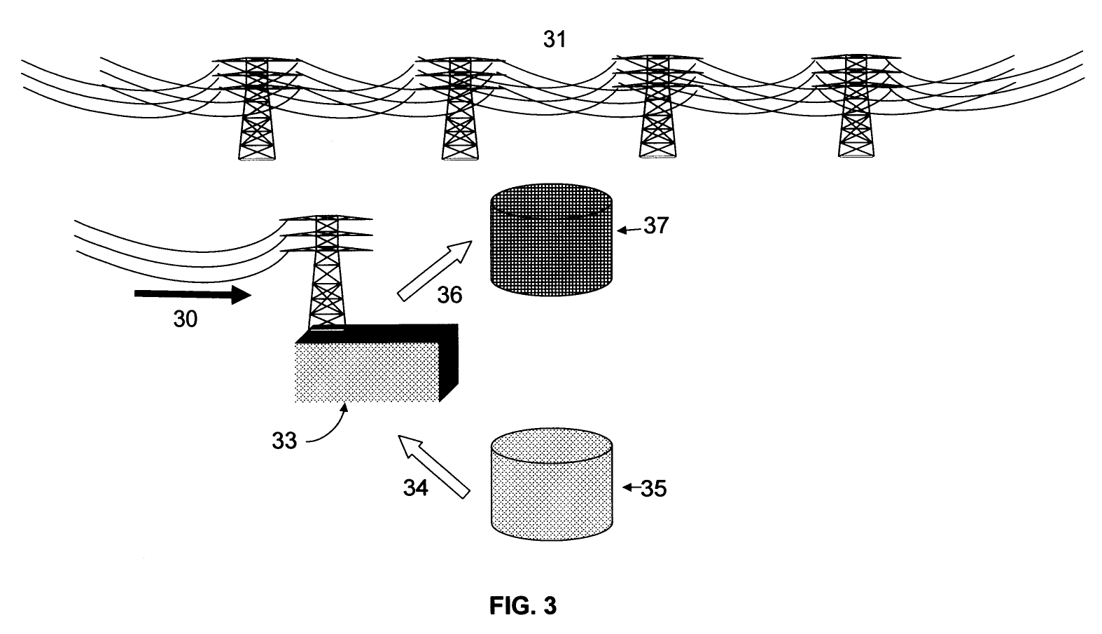

FIG. 3 is a schematic representation of electrical power 30 being collected from electric power grid 31. Electric power 30 is used by electrochemical charger 33 to convert low energy electrochemistry waste 34 from waste storage tank 35 into higher energy electrochemistry 36 and store it in electrochemical fuel tank 37. This charging function can be accomplished whenever the voltage level of the electric power grid indicates excess energy is available, or whenever the system is manually started. The charging function is particular to the electrochemistry selected and will vary widely depending on particular combinations and physical forms. During times of low voltage or high demand the charging system will not operate and will not place additional load on the electric power grid. In this manner the charging function proceeds only when excess energy is available for storage.

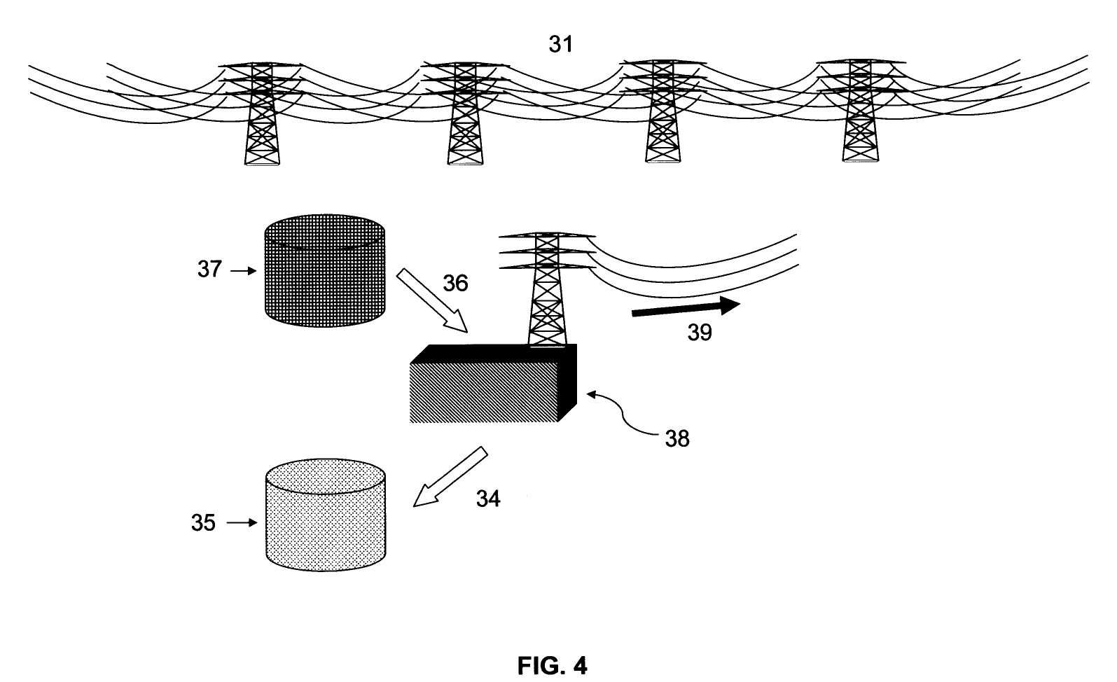

FIG. 4 is a schematic representation of electrical power 39 being generated and supplied to electric power grid 31. High energy electrochemical fuel 36 from electrochemical fuel tank 37 is moved in to discharge cell 38. Discharge cell 38 is comprised of the herein described metal-metal cell further comprised as a battery coupled to an appropriate electronic inverter to convert the direct current electricity supplied by the metal-metal cell battery to alternating current suitable for the electric power grid 31 in terms of voltage, frequency and phase. Discharge cell 38 converts the electrochemical fuel 36 into electrical power 39 and low energy electrochemistry waste 34. Low energy electrochemistry waste 34 is sent to waste storage tank 35. The rate of discharge can be selected to be very different from the rate of charge. Discharge cell 38 is preferred to be capable of delivering all the stored electrical power to the electric power grid as required. This supply is available on demand as the discharge cell can be connected directly to the electric power grid providing immediate compensation for additional current to support electric power grid voltage levels.

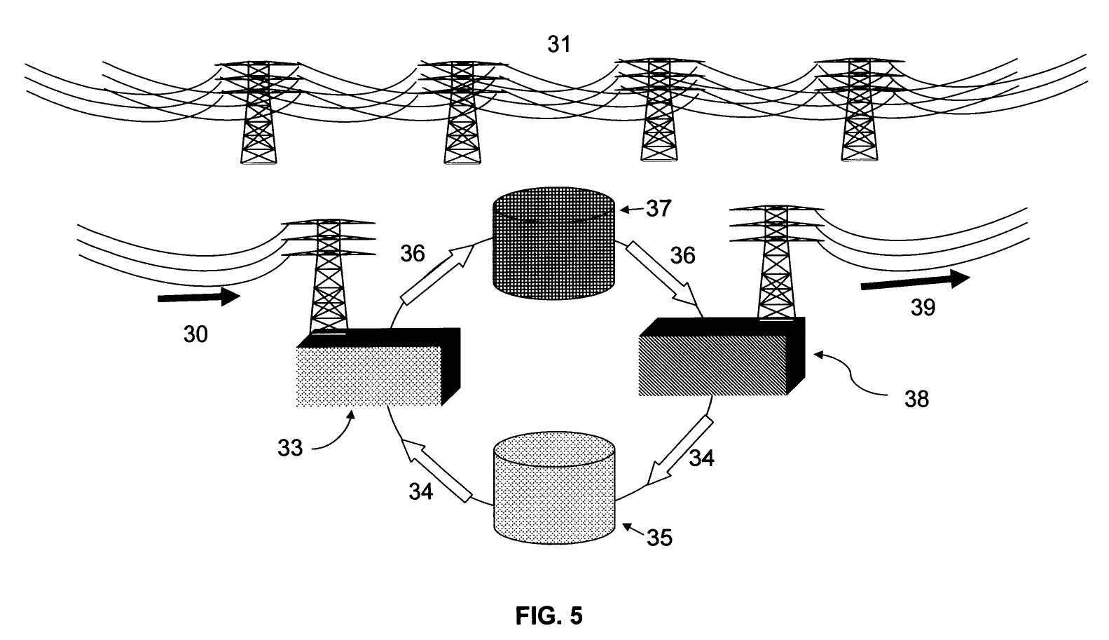

FIG. 5 is a schematic representation of electrical power being collected 30 and returned to the electric power grid 31 upon demand 39. The process of charging 33 and discharging 38 reuses the electrochemistry 34, 35 in a continuous cycle of storage and use. It can be seen that the processes of charging 33 and storing 37 are completely independent and electrically decoupled from the process of discharging 38 and storage 35. In the preferred case of a metal-metal cell, it is understood that two streams of electrochemistry are represented by 34 and 36, and that dual processes occur in 33 and 38, and that storage may also be dual in nature as required in 35 and 37.

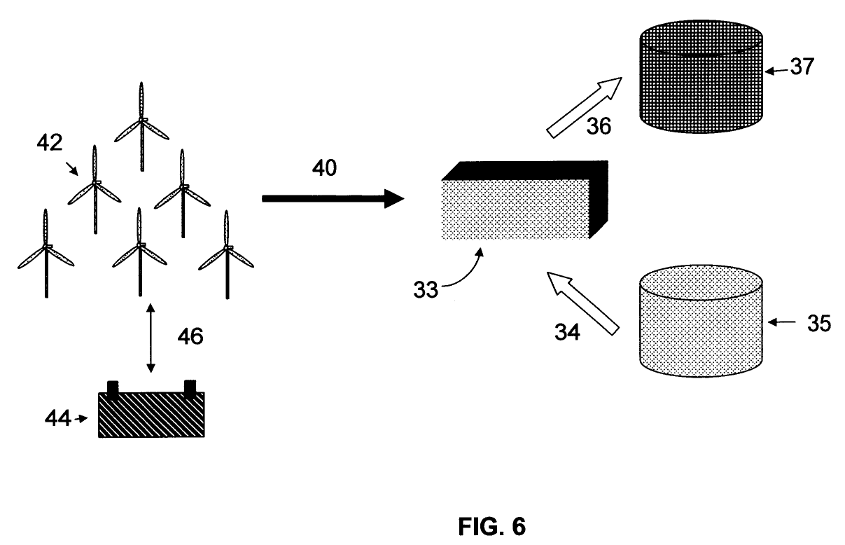

FIG. 6 is a schematic representation of electrical power 40 being collected from a renewable energy source, in this case electric power generating wind turbines 42. Electric power 40 is used by electrochemical charger 33 to convert low energy electrochemistry waste 34 from waste storage tank 35 into higher energy electrochemistry 36 and store it in electrochemical fuel tank 37. This charging function is accomplished whenever the voltage level of the electric power from the wind turbines is sufficient to drive the charging process. The electrical power from the wind turbines does not require conditioning before being delivered to the charger 33 and can be delivered in its native direct current, or rectified alternating current. It is a preferred embodiment of the present application that the charger is a power driven electrochemical process that can store energy as it is delivered without correction or buffering. Starter battery 44 supplies electrical current 46 to the wind turbine generators when required for starting inrush current. When the wind turbines 42 are operating at a sufficient level, the starting inrush current of any wind turbine generator is supplied by the wind turbines 42, and when the operating level of wind turbines 42 is sufficient, the starting battery 44 is recharged by electrical current 46.

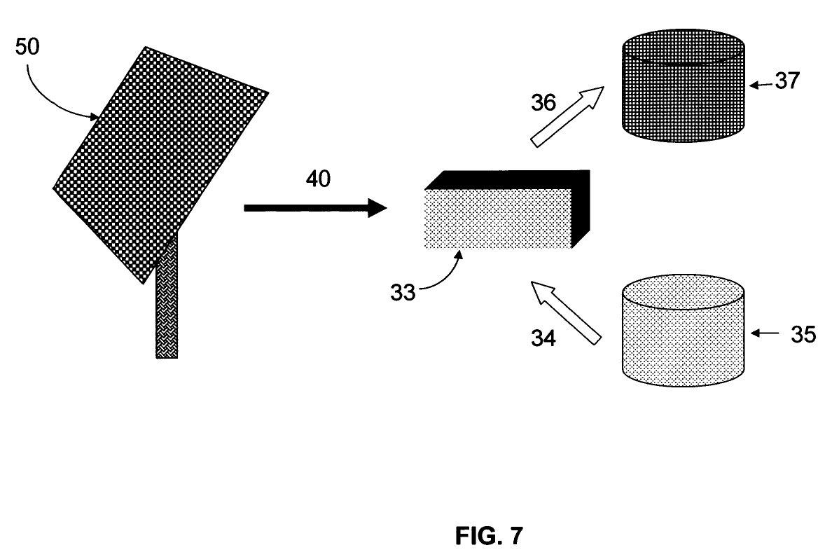

FIG. 7 is a schematic representation of electrical power 40 being collected from renewable energy source, in this case a photovoltaic cell in a solar collection array 50. Electric power 40 is used by electrochemical charger 33 to convert low energy electrochemistry waste 34 from waste storage tank 35 into higher energy electrochemistry 36 and store it in electrochemical fuel tank 37. This charging function is accomplished whenever the voltage level of the electric power from the solar array is sufficient to drive the charging process. The electrical power from the solar array does not require conditioning before being delivered to the charger 33 and can be delivered in its native direct current. It is a preferred embodiment of the present application that the charger is a power driven electrochemical process that can store energy as it is delivered without correction or buffering.

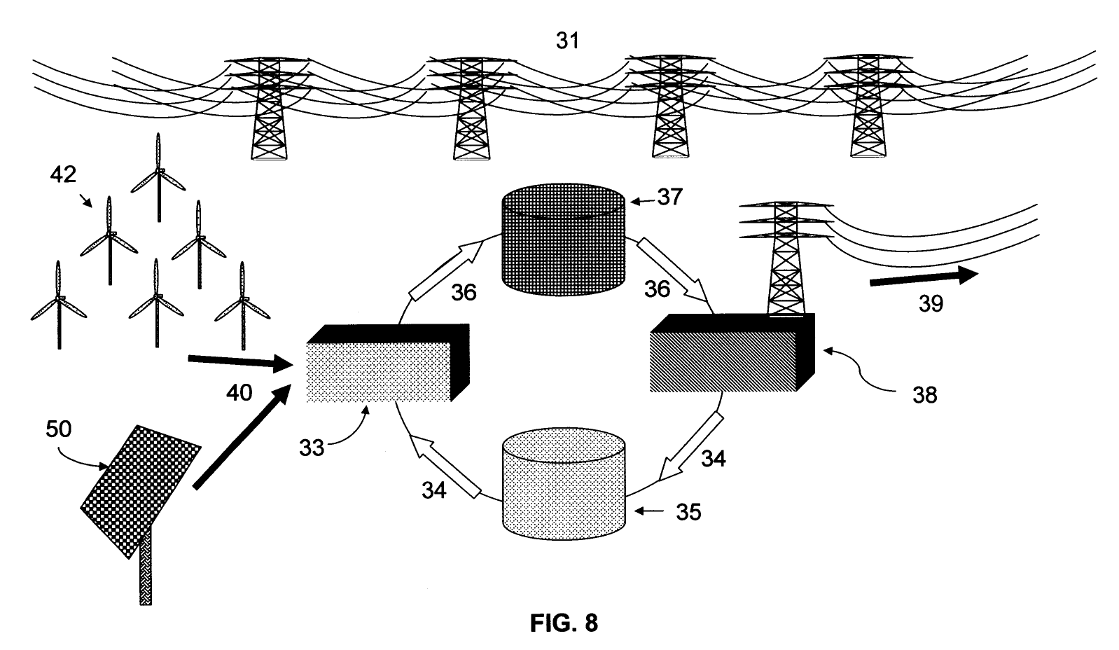

FIG. 8 is a schematic representation of electrical power 40 being collected from multiple renewable energy sources 42 and 50. Electric power 40 is used by electrochemical charger 33 to convert low energy electrochemistry waste 34 from waste storage tank 35 into higher energy electrochemistry 36 and store it in electrochemical fuel tank 37. This charging function is accomplished whenever the voltage level of the electric power from the wind turbines is sufficient to drive the charging process. The electrical power from the renewable power sources 42 and 50 does not require conditioning before being delivered to the charger 33 and can be delivered in its native direct current, or rectified alternating current. It is a preferred embodiment of the present application that the charger is a power driven electrochemical process that can store energy as it is delivered without correction or buffering.

High energy electrochemical fuel 36 from electrochemical fuel tank 37 is moved into discharge cell 38. Discharge cell 38 converts the electrochemical fuel 36 into electrical power 39 and low energy electrochemistry waste 34. Low energy electrochemistry waste 34 is sent to waste storage tank 35. The rate of discharge can be selected to be very different from the rate of charge. Discharge cell 38 is preferred to be capable of delivering all the stored electrical power to the electric power grid 31 as required. This supply is available on demand as the discharge cell 38 is connected directly to the electric power grid 31 so as to provide immediate compensation for additional current to support electric power grid 31 voltage levels. It is a preferred embodiment of the present application that transient and intermittent production from the renewable energy sources 42 and 50 can not reach the electrical power grid 31, and that the electrical power grid 31 is completely isolated from the renewable energy sources 42 and 50.

While particular embodiments of the present application are described above, it will be apparent to those skilled in the art that various changes and modifications may be made therein without departing from the spirit or scope of the application. It will be understood, however, that this disclosure is, in many respects, only illustrative. Changes may be made in details, particularly in matters of shape and size without exceeding the scope of the application.

What I claim is:

1. An electrochemical energy device which comprises a spatially separated electrochemical charging system and electrochemical discharge cell; wherein the electrochemical discharge cell comprises:
a plurality of electrodes;
each electrode having a fuel compartment with input and output sidewalls of dimension h and end walls of dimension w, wherein the fuel compartment is arranged between an input flow plate and output flow channel, the input flow plate adjacent to the input side wall and the output flow channel adjacent to the output side wall of the fuel compartment,
the input flow plate comprising a porous membrane or a plurality of openings through which electrolyte can flow into the fuel compartment from an electrolyte source, wherein the porous membrane or the openings extend substantially along a surface of the input flow plate adjacent to the input side wall of the fuel compartment, thereby providing for the flow of the electrolyte through the fuel compartment in a direction essentially parallel to dimension w and into the output flow channel.

2. The electrochemical energy device of claim 1 further comprising one or more screens that extend substantially between and along the output side wall of the fuel compartment and the output flow channel.

3. The electrochemical energy device of claim 2 wherein at least one of the one or more screens is electrically conductive.

4. The electrochemical energy device of claim 3 comprising at least two or more screens, wherein the pore size of the screens decrease in the direction toward the output flow channel.

5. The electrochemical energy device of claim 1 wherein the input flow plate is electrically conductive.

6. The electrochemical energy device of claim 1 wherein the input flow plate comprises the openings and flaps that extend in the direction of the fuel compartment as electrolyte flows through the openings and into the fuel compartment, whereas the flaps essentially block the openings if there is insubstantial flow of electrolyte.

7. The electrochemical energy device of claim 1 wherein the input flow plate comprises a screen.

8. The electrochemical energy device of claim 1 wherein the output flow channel is partitioned with flow channel members.

9. The electrochemical energy device of claim 8 wherein the flow channel members are electrically conductive.

10. The electrochemical energy device of claim 1 wherein the flow channel members are configured to facilitate the insertion and removal of the electrode from the electrochemical cell.

11. The electrochemical energy device of claim 1 wherein the electrode is cylindrical and centrally arranged in the electrochemical cell and the output flow channel, the fuel compartment and the input flow plate and are cylindrically shaped and arranged in the recited order about the perimeter of the electrode.

12. The electrochemical energy device of claim 1 wherein the electrode is centrally arranged in the electrochemical cell and the cell comprises at least two or more of the output flow channels, at least two or more of the fuel compartments and at least two or more of the input flow plates arranged in the recited order about the electrode.

13. The electrochemical energy device of claim 11 further comprising one or more screens that extend substantially between and along the output side wall of the fuel compartment and the output flow channel.

14. The electrochemical energy device of claim 12 further comprising one or more screens that extend substantially between and along the output side wall of the fuel compartments and the output flow channels.

15. The electrochemical energy device of claim 1 wherein the electrode is an air cathode.

16. The electrochemical energy device of claim 1 wherein the electrode is a metal electrochemical cathode.

17. The electrochemical energy device of claim 16 comprising two or more electrodes, wherein the electrodes are opposing metal electrochemical cells.

18. The electrochemical energy device of claim 1 being an electric power grid buffer.

19. An electrochemical cell for an electric power grid buffer comprising:
a centrally arranged electrode; and
at least two fuel compartments with output and input sidewalls of dimension h and end walls of dimension w, wherein each of the fuel compartments are arranged between an input flow plate and output flow channel, the input flow plate adjacent to the input side wall and the output flow channel adjacent to the output side wall of the fuel compartment, wherein the at least two fuel compartments are symmetrically arranged on either side of the electrode,
the input flow plates comprising a porous membrane or a plurality of openings through which electrolyte can flow into the fuel compartments from an electrolyte source, wherein the porous membrane or the openings extend substantially along a surface of the input flow plates adjacent to the input side wall of the fuel compartments, thereby providing for the flow of the electrolyte through the fuel compartments in a direction essentially parallel to dimension w and into the output flow channels proximate to the electrode.

20. The electrochemical cell of claim 19 further comprising one or more screens that extend substantially between and along the output side wall of the fuel compartments and the output flow channels.

21. The electrochemical cell of claim 20 wherein the screens are conductive.

22. The electrochemical cell of claim 19 comprising at least two or more screens, wherein the pore size of the screens decrease in the direction toward the output flow channels.

23. The electrochemical cell of claim 19 wherein the input flow plates are electrically conductive.

24. The electrochemical cell of claim 19 wherein the output flow channels are partitioned with electrically conductive flow channel members.

25. The electrochemical cell of claim 19 wherein the electrode is an air cathode.

26. The electrochemical cell of claim 19 wherein the electrode is a metal electrochemical cathode.

27. A method of supplying electrical energy to an electric power grid comprising:
providing a flow-through electrochemical cell with an electrode and a fuel compartment with input and output sidewalls, wherein the fuel compartment is arranged between an input flow plate and output flow channel, the input flow plate adjacent to the input side wall and the output flow channel adjacent to the output side wall of the fuel compartment, and the input flow plate includes a porous membrane or a plurality of openings through which electrolyte can flow into the fuel compartment from an electrolyte source;
providing a pulse valve to control the flow of electrolyte from an electrolyte source to the electrochemical cell, wherein the pulse valve provides an electrolyte flow cycle comprising staggered electrolyte flow over a pulse time period and a steady flow of electrolyte over a steady time period; and
repeating a plurality of the electrolyte flow cycles.

28. The method of claim 27 wherein the electric current is produced from electrochemical fuel produced utilizing electric current derived from an electric power grid.

29. The method of claim 27 wherein the electric current is produced from electrochemical fuel produced utilizing electric current derived from a renewable energy source, and the electric current produced is sent to the electric power grid.

30. The method of claim 27 wherein the electric current is produced from stored electrochemical fuel and the electric current produced is used as a stand alone electric generation unit.
